(19) United States
(12) Patent Application Publication
(10) Pub. No.: US 2026/0145571 A1
(43) Pub. Date: May 28, 2026

(54) SYSTEMS AND METHODS FOR CHARGING MANAGEMENT, AND STORAGE MEDIUMS

(71) Applicant: XCHARGE ENERGY USA INC., Kyle, TX (US)

(72) Inventors: Hongyu DAI, Kyle, TX (US); Rui DING, Kyle, TX (US)

(73) Assignee: XCHARGE ENERGY USA INC., Kyle, TX (US)

(21) Appl. No.: 18/957,927

(22) Filed: Nov. 25, 2024

(51) Int. Cl. B60L 53/68; B60L 53/30

(52) U.S. Cl. CPC B60L 53/68; B60L 53/305; B60L 2240/70

(57) ABSTRACT

The present disclosure provides a system and method for charging management, and a storage medium. The system includes a charging pile, an interaction device, and a cloud server. The cloud server is configured to: in response to a determination that a user terminal sends a connection request through a connection request port, obtain state information of a charging pile; in response to a determination that the state information is an idle state, display a charging request page to a user, obtain charging request information of the user; generate a charging parameter based on charging order information; and send a charging command to the charging pile to start charging; and in response to a determination that the state information is a charging state, send an identity verification request to the user; and in response to a determination that the identity verification request is passed, display a charge management page.

### TECHNICAL FIELD

The present disclosure relates to the field of charging, and in particular to a system and a method for charging management, and a storage medium.

### BACKGROUND

With the increasing popularity of electric vehicles, a demand for charging electric vehicles is also growing. Currently, users typically use a charging pile to charge the electric vehicles. When using the charging pile, users usually scan a QR code on the charging pile with their phone using either the built-in camera app or a third-party app or mini-program with scanning capabilities. This takes the users to the charging initiation and payment page. It is common practice to scan the code, select a payment manner to begin charging, and scan the code again to stop charging. Therefore, enhancing the convenience and safety of the charging process for users is an urgent issue in the industry today.

In order to improve user operation convenience, CN110588428B proposes a method, device, electric vehicle, charging pile, and system for charging identification. The method includes receiving a connection request from a charging pile; in response to the connection request, performing authentication on the user; and after the authentication is passed, sending vehicle identity information and vehicle charging permission information to the charging pile to make the charging pile to perform identity verification on the electric vehicle and determination of a permitted charging state, and releasing charging permission after the identity verification is successful and the permitted charging state is determined; receiving the charging permission sent from the charging pile; and in response to the charging permission, controlling a cover of a charging port to open, enabling the charging pile to charge the electric vehicle using a charging gun connected to the charging port. However, the method does not include any identity verification procedure after charging starts or when charging ends.

Therefore, it is necessary to propose a system and a method for charging management, and a storage medium, which can facilitate fast and convenient charging while minimizing user operation time and a risk of privacy leakage.

### SUMMARY

One or more embodiments of the present disclosure provide a system for charge management. The system includes a charging pile, an interaction device, and a cloud server. The interaction device is matched with the charging pile. The charging pile is configured to charge a target charging device. The interaction device is configured to present a connection request port corresponding to the charging pile to a user. The cloud server is configured to: in response to a determination that a user terminal sends a connection request through the connection request port, obtain state information of the charging pile; in response to a determination that the state information is an idle state, display a charging request page to the user via the user terminal and obtain charging request information of the user, the charging request information including at least one of charging order information and identity verification information; generate a charging parameter based on the charging order information, the charging parameter including at least one of a charging voltage, a charging current, and a charging power; and send a charging command to the charging pile to start charging; and in response to a determination that the state information is a charging state: send an identity verification request to the user via the user terminal; and in response to a determination that the identity verification request is passed, display a charge management page to the user via the user terminal, the charge management page being configured to display at least one of the charging parameter and an estimated charging duration to the user.

One or more embodiments of the present disclosure provide a method for charge management. The method includes: in response to a determination that a user terminal sends a connection request through a connection request port corresponding to a charging pile, obtaining state information of the charging pile, the connection request port being displayed by an interaction device to a user; in response to a determination that the state information is an idle state: displaying a charging request page to the user via the user terminal and obtain charging request information of the user, the charging request information including at least one of charging order information and identity verification information; generating a charging parameter based on the charging order information, the charging parameter including at least one of a charging voltage, a charging current, and a charging power; and sending a charging command to the charging pile to start charging a target charging device by the charging pile; and in response to a determination that the state information is a charging state: sending an identity verification request to the user via the user terminal; and in response to a determination that the identity verification request is passed, displaying a charge management page to the user via the user terminal, the charge management page being configured to display at least one of the charging parameter and an estimated charging duration to the user.

One or more embodiments of the present disclosure provide a non-transitory computer-readable storage medium storing a set of computer instructions. When a computer reads the computer instructions in the storage medium, the method for charge management is implemented.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating an exemplary system for charging management according to some embodiments of the present disclosure;

FIG. 2 is a flowchart illustrating an exemplary process for charging management according to some embodiments of the present disclosure;

FIG. 3 is a schematic diagram illustrating an exemplary parameter determination model according to some embodiments of the present disclosure;

FIG. 4 is a flowchart illustrating an exemplary process for determining a reference charging record according to some embodiments of the present disclosure; and

FIG. 5 is a flowchart illustrating an exemplary process for charging management according to some embodiments of the present disclosure.

### DETAILED DESCRIPTION

In the following detailed description, numerous specific details are set forth by way of examples in order to provide a thorough understanding of the relevant disclosure. Obviously, drawings described below are only some examples or embodiments of the present disclosure.

It will be understood that the terms “system,” “device,” “unit,” and/or “module” used herein are one method to distinguish different components, elements, parts, sections, or assemblies of different levels in ascending order. However, the terms may be displaced by other expressions if they may achieve the same purpose.

The terminology used herein is for the purposes of describing particular examples and embodiments only and is not intended to be limiting. As used herein, the singular forms “a,” “an,” and “the” may be intended to include the plural forms as well, unless the context clearly indicates otherwise. It will be further understood that the terms “include” and/or “comprise,” when used in this disclosure, specify the presence of elements and operations, but do not exclude the presence or addition of one or more other elements or operations.

When the operations performed by the step description are described in the embodiments of the present disclosure, unless otherwise specified, the order of the operations is interchangeable, the operations may be omitted, and other operations may also be included during the process.

The rise in electric vehicle popularity has increased the demand for charging. A manner of scanning a code to select a payment option and start charging, and then scanning again to stop charging, requires users to bind or register an account and set up a payment manner. This process entails certain time, operational, and privacy leakage costs, especially for first-time users of the operator's charging piles. Additionally, once charging begins, anyone can scan the code to check the charging state or end the charging, which may lead to a situation where the user returns after some time to find that someone else has already stopped the charging without fully charging the vehicle.

In view of the above, some embodiments of the present disclosure are expected to provide a system for charging management that allows users to start charging without going through complicated binding and registration processes. It also addresses privacy concerns so that users can charge their devices more quickly and conveniently.

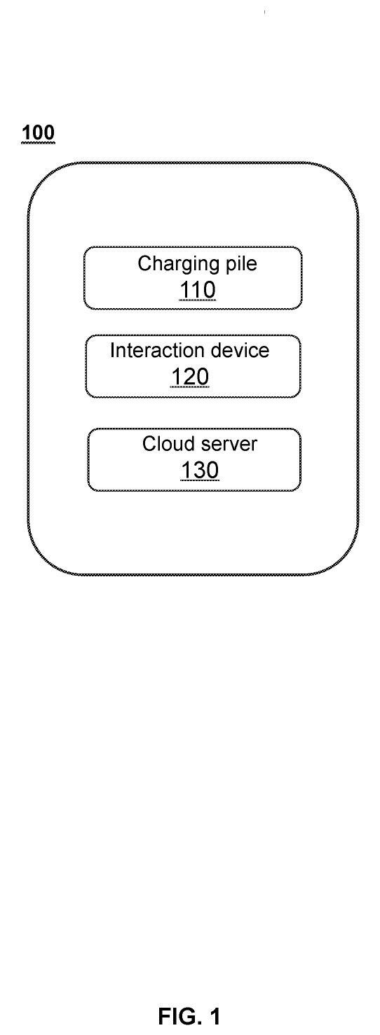

FIG. 1 is a schematic diagram illustrating an exemplary system for charging management according to some embodiments of the present disclosure. As shown in FIG. 1, a system 100 for charging management may include a charging pile 110, an interaction device 120, and a cloud server 130.

The charging pile 110 refers to a physical device that provides electrical energy. In some embodiments, the charging pile 110 is configured to charge a target charging device.

The target charging device refers to an object to be charged. In some embodiments, the target charging device may be an electric vehicle, an electric motorcycle, an electric bicycle, or the like. The electric vehicle may include a plug-in pure electric vehicle, a plug-in hybrid electric vehicle, or the like.

The interaction device 120 refers to a device that enables a user to interact with the system 100 for charging management. In some embodiments, the interaction device 120 may include a display screen, a paper QR code, a paper bar code, or the like. In some embodiments, the interaction device 120 is configured to present a connection request port corresponding to the charging pile to the user .

In some embodiments, the interaction device 120 is matched with the charging pile 110.

The connection request port is a port through which the user interacts with the system 100 for charging management. In some embodiments, the connection request port may be in the form of one or more of a QR code, a link address, a near field communication (NFC) induction, or the like.

In some embodiments, the interaction device includes a communication unit, and the communication unit is configured to: in response to a determination that charging request information is obtained, send a communication connection request to the user terminal; in response to a determination that the communication connection request is passed, obtain a communication address of the user terminal; scan the communication address in real time during a charging process; and in response to a determination that the communication address is scanned, display the connection request port to the user via the interaction device.

The cloud server 130 may process data and/or information obtained from at least one of the devices (e.g., the charging pile 110 and the interaction device 120) in the system for charging management 100 or an external data source (e.g., a cloud data center). In some embodiments, the cloud server 130 may be a single server or a server group. The server group may be centralized or distributed. In some embodiments, the cloud server 130 may be implemented on a cloud platform. Merely by way of example, the cloud platform may include a private cloud, a public cloud, a hybrid cloud, a community cloud, a distributed cloud, an on-premises cloud, a multi-tiered cloud, etc., or any combination thereof.

The cloud server 130 is a computing service provider for the system 100 for charging management, and the cloud server 130 may process or store received data.

In some embodiments, the cloud server 130 is communicatively connected to the system 100 for charging management. For example, the cloud server 130 is connected to the interaction device 120 via a network. It is to be noted that all of the communication connections mentioned later may be implemented via a network, which may include a public network (e.g., the Internet), a private network (e.g., a local area network (LAN) and a wide area network (WAN)), etc., or a combination thereof.

In some embodiments of the present disclosure, the cloud server is configured to: in response to a determination that a user terminal sends a connection request through the connection request port, obtain state information of the charging pile; in response to a determination that the state information is an idle state, display a charging request page to the user via the user terminal and obtain charging request information of the user, the charging request information including at least one of charging order information and identity verification information; generate a charging parameter based on the charging order information, the charging parameter including at least one of a charging voltage, a charging current, and a charging power; and send a charging command to the charging pile to start charging; and in response to a determination that the state information is a charging state: send an identity verification request to the user via the user terminal; and in response to a determination that the identity verification request is passed, display a charge management page to the user via the user terminal, the charge management page being configured to display at least one of the charging parameter and an estimated charging duration to the user.

In some embodiments of the present disclosure, the cloud server is further configured to: obtain a reference charging record of the user based on the charging order information; and determine the charging parameter based on the reference charging record.

In some embodiments of the present disclosure, the cloud server is further configured to: determine the charging parameter based on the reference charging record using a parameter determination model, the parameter determination model being a machine learning model, the parameter determination model including a feature determination layer and a parameter determination layer. An input of the feature determination layer includes the reference charging record and pre-charging data, and an output of the feature determination layer includes a comparison feature. An input of the parameter determination layer includes the comparison feature, a pre-charging parameter, battery information, and a charging requirement, and an output of the parameter determination layer includes the charging parameter.

In some embodiments of the present disclosure, he reference charging record includes a first reference record and a second reference record, the first reference record is determined based on a historical charging record corresponding to the user terminal, the second reference record is determined based on a historical charging record corresponding to a reference terminal, and the reference terminal is a terminal other than the user terminal. The comparison feature includes a first comparison feature and a second comparison feature, the first comparison feature corresponding to the first reference record, the second comparison feature corresponding to the second reference record. Training of the parameter determination model includes: determining a model learning rate based on a ratio of the first reference record to the second reference record in a training sample.

In some embodiments of the present disclosure, the cloud server is further configured to: determine a pre-charging parameter based on the charging order information; pre-charge the target charging device, and obtain pre-charging data during a pre-charging process; identify whether the user terminal is a historical user terminal through the communication unit; in response to a determination that the user terminal is a historical user terminal, obtain a historical charging record corresponding to the user terminal; filter the historical charging record based on the pre-charging data; and determine a reference charging record based on the filtered historical charging record.

In some embodiments of the present disclosure, in response to the determination that the state information is a charging state, the cloud server is further configured to: obtain charging data in real time, and determine a current charging state based on the charging data; generate a charging management parameter based on the current charging state, the charging management parameter including at least one of a charging adjustment parameter and a charging reminder parameter; and send the charging management parameter to the charge management page to alert an administrator, the administrator including the user and a management staff.

In some embodiments of the present disclosure, the cloud server is further configured to: determine a reference charging trend based on the charging parameter and a first reference record; and determine the current charging state based on the charging data and the reference charging trend.

In some embodiments of the present disclosure, the cloud server is further configured to: determine an abnormal cause based on the charging data, the charging parameter, the current charging state, and a reference charging trend using an anomaly analysis model, the anomaly analysis model being a machine learning model; and determine the charging adjustment parameter based on the abnormal cause.

In some embodiments of the present disclosure, the cloud server is further configured to: in response to a determination that the user submits the charging order information, send a push permission request to the user via the charge management page; in response to a determination that the user agrees to the push permission request, obtain positioning information of the user at a preset node; and determine the charging reminder parameter based on the positioning information and a charging progress to send a completion reminder message to the user.

In some embodiments of the present disclosure, the cloud server is further configured to: determine the preset node based on battery level distribution information of the user, the battery level distribution information being related to a plurality of battery levels when the user ends charging in a plurality of historical charging records.

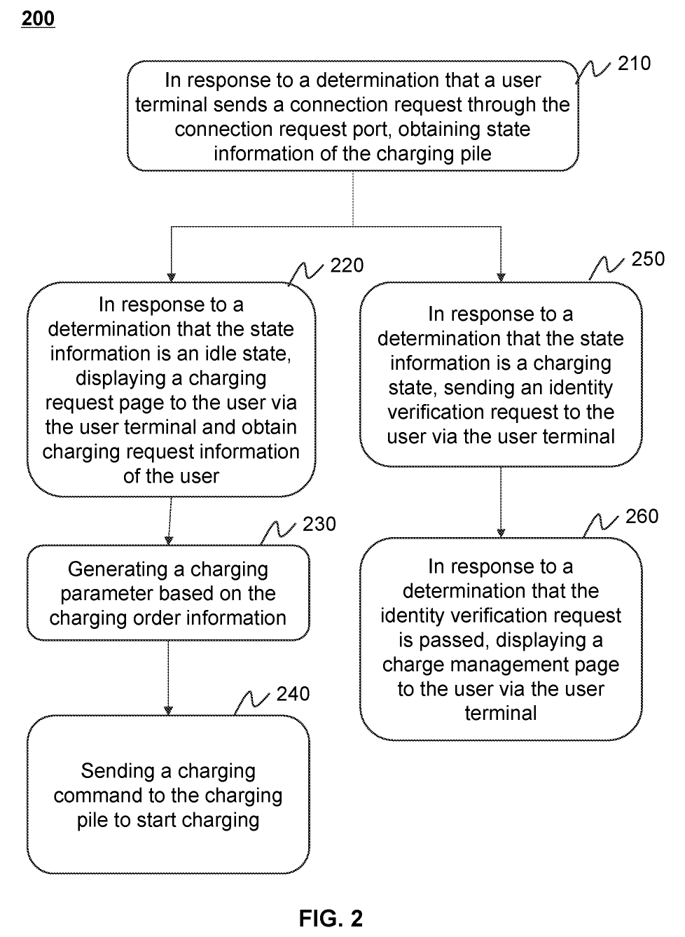

More descriptions regarding the charging pile 110, the interaction device 120, and the cloud server 130 may be found elsewhere in the present disclosure (e.g., FIGS. 2-5 and related descriptions thereof).

It should be noted that the system for charging management is provided for illustrative purposes only and is not intended to limit the scope of the present disclosure. For a person of ordinary skill in the art, a variety of modifications or variations may be made in accordance with the description of the present disclosure. For example, the system for charging management may also include a database. As another example, the system for charging management may be implemented on other devices to perform similar or different functions. Changes and modifications, however, do not depart from the scope of the present disclosure.

FIG. 2 is a flowchart illustrating an exemplary process for charging management according to some embodiments of the present disclosure. As shown in FIG. 2, process 200 includes operations 210-260 as described below. In some embodiments of the present disclosure, process 200 may be performed by a cloud server.

In some embodiments of the present disclosure, a method for charging management is performed by a cloud server, and the method includes: in response to a determination that a user terminal sends a connection request through a connection request port corresponding to a charging pile, obtaining state information of the charging pile, the connection request port being displayed by an interaction device to a user; in response to a determination that the state information is an idle state: displaying a charging request page to the user via the user terminal and obtain charging request information of the user, the charging request information including at least one of charging order information and identity verification information; generating a charging parameter based on the charging order information, the charging parameter including at least one of a charging voltage, a charging current, and a charging power; and sending a charging command to the charging pile to start charging a target charging device by the charging pile; and in response to a determination that the state information is a charging state: sending an identity verification request to the user via the user terminal; and in response to a determination that the identity verification request is passed, displaying a charge management page to the user via the user terminal, the charge management page being configured to display at least one of the charging parameter and an estimated charging duration to the user.

In 210, in response to the determination that the user terminal sends the connection request through the connection request port, the state information of the charging pile may be obtained. More descriptions regarding the charging pile and the connection request port may be found in FIG. 1 and related description thereof.

The user terminal refers to a device used by the user to interact with the system for charging management. For example, the user terminal may include a desktop computer, a tablet computer, a smartphone, or the like.

The connection request refers to a request to establish a connection between the target charging device and the charging pile.

In some embodiments, the user terminal may send the connection request to the charging pile via the connection request port in the interaction device. For example, the user terminal sends the connection request to the charging pile by scanning a QR code. As another example, the user terminal sends the connection request to the charging pile by inputting the identity verification information. As a further example, the user terminal sends the connection request to the charging pile by sensing a NFC chip through a smartphone with Near Field Communication (NFC).

In some embodiments, the connection request port may be displayed to the user by the interaction device. More descriptions regarding the interaction device may be found in FIG. 1 and related description thereof.

The user refers to a person who uses the system for charging management. In some embodiments, the user may include a user who charges the target charging device. The target charging device may include an electric vehicle, an electric motorcycle, an electric bicycle, or the like, to be charged.

In some embodiments, the cloud server may obtain the state information of the charging pile corresponding to the connection request port in response to a determination that the connection request port sends the connection request.

The state information refers to charging state information of the charging pile. In some embodiments, the state information includes an idle state and a charging state.

The idle state refers to a state in which the charging pile is not charging the target charging device. For example, when the charging pile is not connected to the target charging device, the state information of the charging pile is the idle state.

The charging state refers to a state in which the charging pile is charging the target charging device. For example, the charging state may be a state in which the charging pile is connected to the target charging device and is delivering power to the target charging device.

In some embodiments, in response to a determination that the state information is the idle state, the cloud server performs operations 220-240. In some embodiments, in response to a determination that the state information is the charging state, the cloud server performs operations 250-260.

In 220, in response to the determination that the state information is the idle state, the charging request page may be displayed to the user via the user terminal and the charging request information of the user may be obtained.

The charging request page refers to a page where the user places an order for charging. In some embodiments, the user may view state exception information, a supported charging power, a charging price, or the like, of a current charging pile through the charging request page. The state exception information refers to information that determines whether the state of the current charging pile is abnormal. For example, when the charging pile is in the idle state, the charging request page displays whether the charging pile is in the idle state because of a malfunction in the charging pile. The charging power may include a plurality of gears; for example, the charging power may include three gears including 30 KW, 60 KW, and 100 KW.

In some embodiments, the cloud server may display the charging request page to the user via the user terminal.

In some embodiments, the user may use the charging pile in the idle state for charging, and the user may submit the charging request information to the cloud server via the charging request page to start charging.

The charging request information refers to information of requesting the charging pile to start charging.

In some embodiments, the charging request information may include at least one of the charging order information and the identity verification information.

The charging order information refers to a charging requirement selected by the user. For example, the charging requirement may include a charging power gear, a charging stop condition, or the like, which are selected by the user.

The charging power gear may be determined based on a charging power supported by the target charging device. For example, the charging power gear may be gear 1, gear 2, gear 3, or the like. The charging stop condition may include the battery level reaching a battery preset value, a charging cost reaching a cost preset value, or the like. For example, the battery preset value may be a full battery level, a battery level of 80%; and the cost preset value may be $10, $20, etc.

In some embodiments, the charging power gear selected by the user may determine an upper limit of a current charging power. For example, a maximum charging power supported by the target charging device is 70 KW, and the charging power corresponding to gear 2 selected by the user on the charging order information via the user terminal is 60 KW; then the upper limit of the current charging power for the charging pile charging the target charging device is 60 KW.

In some embodiments, the cloud server may obtain the charging order information through a charging request page displayed on the user terminal and entered directly by the user.

The identity verification information refers to information used to verify the identity of the user. In some embodiments, the identity verification information may include a character verification code, a biometric verification code, a marker, or the like. The character verification code and the biometric verification code may be collectively referred to as identity verification codes. The character verification code includes one or a combination of at least two of a numeric verification code, an alphabetic verification code, and a pattern verification code. The biometric verification code includes one or a combination of at least two of a fingerprint verification code, a face verification code, and a voiceprint verification. The marker includes a cookie.

In some embodiments, the cloud server may obtain the identity verification information by entering the character verification code and/or the biometric verification code by the user via the charging request page displayed on the user terminal. In some embodiments, the cloud server may generate a marker and set the marker on the user terminal to obtain the identity verification information. In some embodiments, while generating the marker and setting the marker on the user terminal, the marker is sent based on a cell phone number, an email address, or the like, that the user has reserved.

In 230, the charging parameter may be generated based on the charging order information.

The charging parameter refers to a parameter by which the charging pile charges the target charging device. In some embodiments, the charging parameter may include at least one of the charging voltage, the charging current, and the charging power. The charging voltage, the charging current, and the charging power are the voltage, the current, and the power, respectively, that are output when the charging pile is charging.

In some embodiments, the cloud server may generate the charging parameter based on the charging order information entered by the user through querying a default parameter table.

For example, the cloud server may query the fault parameter table based on the charging power gear entered by the user, and use a default charging parameter corresponding to the charging power gear as the charging parameter. The default charging parameter refers to a charging parameter that is set by default by the cloud server or a technician based on priori experience, and one charging power gear corresponds to one default charging parameter.

In some embodiments, the cloud server may also obtain a reference charging record of the user based on the charging order information, and determine a charging parameter based on the reference charging record.

The reference charging record refers to a charging record used to determine a charging parameter.

In some embodiments, the reference charging record may include an initial battery level, a charging parameter curve, a final battery level, a charging duration, a charging log, or the like.

The initial battery level refers to a battery level of the target charging device before charging. The initial battery level may be either absolute state-of-charge (ASOC) or relative state-of-charge (RSOC). The charging parameter curve may include at least one of a voltage curve, a current curve, a power curve, or the like. The final battery level refers to a battery level after charging of the target charging device is completed. The charging duration refers to a duration required for the target charging device to start charging and complete charging. The charging log refers to a log file that records a charging parameter and state information of the target charging device during the charging process. The charging log may include data such as charging start and end times, the charging current, the charging voltage, the charging power, a battery temperature, a battery level, or the like.

In some embodiments, the cloud server may designate a charging record that is the same as the charging power gear and the charging stop condition selected by the user in the charging order information submitted by the user as the reference charging record.

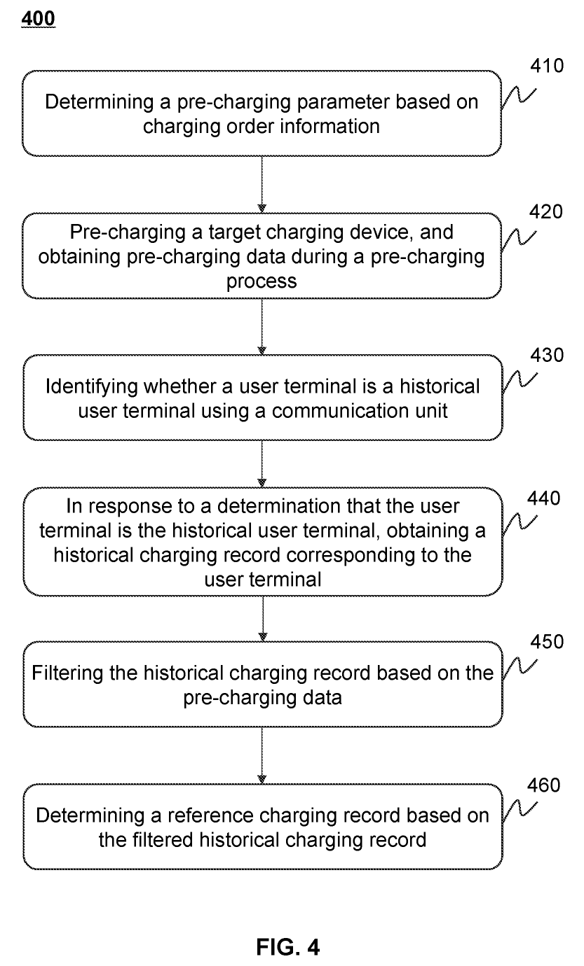

Some other embodiments regarding determining the pre-charging parameter based on the charging order information, pre-charging to obtain the pre-charging data, recognizing the historical user terminal, and filtering the historical charging record to finally determine the reference charging record may be found in FIG. 4 and related description thereof.

In some embodiments, for each reference charging record, the cloud server may perform an integral calculation based on the charging parameter curve of the entire charging process to obtain a battery level output by the charging pile; determine the an increased battery level through an absolute value of a difference between the initial battery level and the final battery level; at the same time, determine the charging efficiency of the charging pile based on the battery level output by the charging pile and the absolute value; and designate a charging parameter corresponding to a reference charging record with a highest charging efficiency as a charging parameter of a current charging order. The charging efficiency may characterize the utilization rate of the electrical energy output by the charging pile, and may be represented by a ratio of the absolute value and the battery level output by the charging pile.

In some embodiments of the present disclosure, the reference charging record is obtained based on the charging order information and further the charging parameter is determined, which is conducive to determining the charging parameter with the higher charging efficiency, then reducing the charging duration, thereby improving the utilization rate of the electric energy, avoiding energy waste, reducing battery heating, and further reducing battery damage.

In 240, the charging command may be sent to the charging pile to start charging the target charging device by the charging pile.

The charging command refers to an instruction that requires the charging pile to charge the target charging device.

In some embodiments, the charging command may include the charging parameter.

In some embodiments, in response to a determination that the charging command is received by the charging pile from the cloud server, the charging pile releases a charging current to the target charging device through a charging cable to start charging. The charging cable is a component that connects the charging pile to the target charging device.

In 250, in response to the determination that the state information is the charging state, the identity verification request may be sent to the user via the user terminal.

The identity verification request refers to a request to verify the identity verification information.

In some embodiments, the identity verification request may be displayed to the user via the user terminal. For example, the cloud server may display a window to enter the verification code to the user via the user terminal. It should be noted that the above-mentioned verification code may be a temporary password that is only valid for a current charging order, thereby reducing a time cost of a series of operations such as user registration, login, and binding payment methods, and reducing a risk of account theft and personal information leakage.

In 260, in response to the determination that the identity verification request is passed, the charge management page may be displayed to the user via the user terminal.

In some embodiments, the cloud server may determine whether the identity verification request passes or not based on the identity verification information entered by the user.

For example, if the user enters the correct verification code, the identity verification request is judged to be passed; and if the user enters an incorrect verification code, the identity verification request is judged to be failed.

In some embodiments, the cloud server may determine whether the identity verification request passes or not based on that whether there is a marker on the user terminal.

For example, if the cloud server scans to determine that there is a reserved cookie on the user terminal, the identity verification is judged to be passed; and if the cloud server scans to determine that there is no reserved cookie on the user terminal, the identity verification is judged to be failed. More descriptions regarding the cookie may be found in the previous description.

The charge management page refers to a page that manages charging orders and displays a state of the target charging device.

In some embodiments, the charge management page may be configured to display at least one of the charging parameter and the estimated charging duration to the user. More descriptions regarding the charging parameter may be found in the previous related description.

In some embodiments, the charge management page may also include information such as a charging progress, an account balance, or the like.

The charging progress refers to a current percentage of the battery level of the target charging device, and the account balance refers to a balance that the user uses to establish charging orders.

The estimated charging duration refers to an estimated length of time between a current moment and a completion moment of charging. For example, if the current moment is 3:00 PM and charging is expected to be completed at 4:00 PM, the estimated charging duration is 1 hour.

In some embodiments of the present disclosure, according to the state information of the charging pile, the charging parameter is determined through the charging request information, and the charging command is further sent for charging, or the charge management page is displayed based on the identity verification information, which is favorable to managing the charging work of the charging pile, reducing manual work, and thus reducing labor costs; and also helps prevent other users from connecting to the charging pile, resulting in interruption of charging. It also helps the user to view a charging situation in detail through the user terminal, which enhances the convenience of displaying the charging situation, at the same time, avoids the need for the user to register for an account and bind the payment when using the charging pile for the first time, thereby reducing the time cost for the user to use the charging pile for the first time and reduces the possibility of privacy leakage.

It should be noted that the foregoing description of the process 200 is intended to be exemplary and illustrative only and does not limit the scope of application of the present disclosure. For a person skilled in the art, various corrections and changes may be made to the process 200 under the guidance of the present disclosure. However, these corrections and changes remain within the scope of the present disclosure.

In some embodiments, the interaction device may include a communication unit, the communication unit is configured to, in response to a determination that the charging request information is obtained, send a communication connection request to the user terminal; in response to a determination that the communication connection request is passed, obtain a communication address of the user terminal; scan the communication address in real time during a charging process; and in response to a determination that the communication address is scanned, display the connection request port to the user via the interaction device.

The communication unit refers to a component for obtaining the communication address of the user terminal.

In some embodiments, the communication unit may include, but is not limited to, a Bluetooth communication module, a near field communication (NFC) module, a Wifi communication module, a ZigBee communication module, an ultra-wideband (UWB) communication module, a radio frequency identification (RFID) communication module, a dedicated short-range communication (DSRC) module, or the like, or any combination thereof.

The communication connection request refers to a request for a communication connection between the communication unit and the user terminal.

For example, the communication connection request may be a request for Bluetooth pairing between the communication unit and the user terminal.

In some embodiments, the communication unit may search for nearby Bluetooth devices to send a connection request to the user terminal.

The communication address refers to an address used to identify the user terminal, and each user terminal has a unique communication address. For example, the communication address may be the Bluetooth address of the user terminal.

In some embodiments, in response to a determination that the communication connection request is passed, the communication unit automatically obtains the communication address of the user terminal.

In some embodiments, the cloud server may display the connection request port via the interaction device. For example, the cloud server may display a connection QR code to the user via a display screen.

In some embodiments of the present disclosure, when the interaction device is the display screen, the user moves away from the charging pile and the display screen hibernates to conserve the battery level. When the user is close to the charging pile and the charging pile scans for the communication address, the display screen is automatically illuminated to show the connection request port. This makes it easier and more timely for the user to see the connection request port without having to manually light up the display screen.

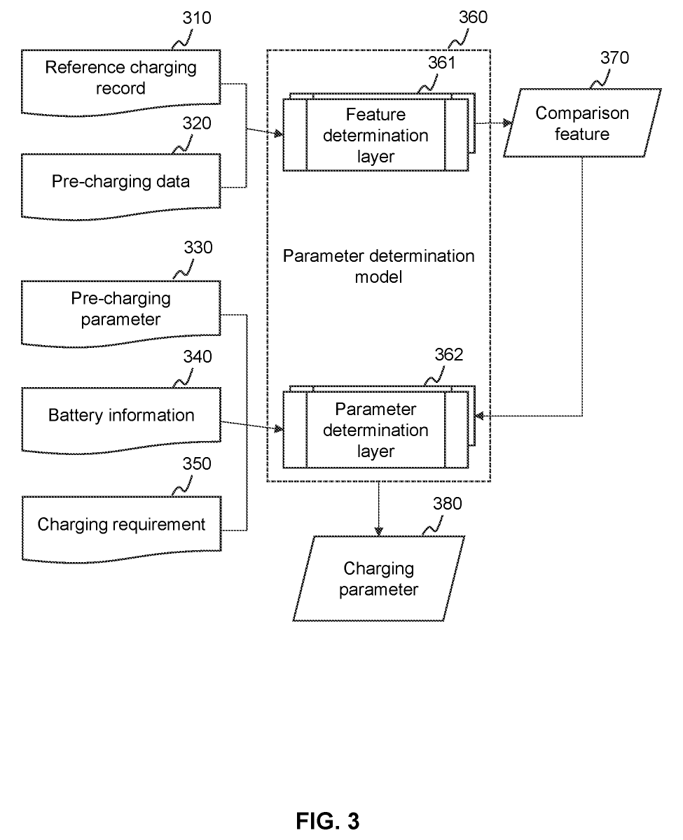

FIG. 3 is a schematic diagram illustrating an exemplary parameter determination model according to some embodiments of the present disclosure.

In some embodiments, a cloud server of the system for charging management is further configured to determine a charging parameter based on a reference charging record using a parameter determination model, the parameter determination model being a machine learning model. The parameter determination model includes a feature determination layer and a parameter determination layer. An input of the feature determination layer includes the reference charging record and pre-charging data, and an output of the feature determination layer includes a comparison feature. An input of the parameter determination layer includes the comparison feature, a pre-charging parameter, battery information, and a charging requirement, and an output of the parameter determination layer includes the charging parameter.

A parameter determination model 360 refers to a model used to determine charging parameter. In some embodiments, the parameter determination model 360 may be a machine learning model, e.g., a convolutional neural network (CNN), a recurrent neural network (RNN), or the like.

In some embodiments, the parameter determination model 360 may include a feature determination layer 361 and a parameter determination layer 362.

The feature determination layer 361 refers to a model for determining the comparison feature. In some embodiments, the feature determination layer 361 may be a machine learning model, e.g., a CNN, etc.

In some embodiments, as illustrated in FIG. 3, an input of the feature determination layer 361 includes a reference charging record 310 and pre-charging data 320, and an output of the feature determination layer 361 may include a comparison feature 370.

The pre-charging data 320 refers to a charging voltage, a charging current, a charging power, and other data that are actually measured during a pre-charging process. The pre-charging process refers to a test charging process of a target charging device. The cloud server may test the actual charging data of a vehicle battery during charging through the pre-charging, so as to select an appropriate reference charging record based on the actual charging data.

In some embodiments, the cloud server may perform pre-charging based on the pre-charging parameter, and obtain the pre-charging data during the pre-charging process.

The pre-charging parameter refers to a parameter for pre-charging the target charging device. In some embodiments, the cloud server may designate a default charging parameter corresponding to a charging order information as the pre-charging parameter. More descriptions regarding the default charging parameter may be found in FIG. 2 and related descriptions thereof.

The comparison feature refers to a feature that compares the pre-charging data with the reference charging record. For example, there may be at least one reference charging record, and the cloud server compares each reference charging record with the pre-charging data to obtain at least one comparison feature. More descriptions regarding the reference charging record may be found in FIG. 2 and related descriptions thereof.

In some embodiments, the cloud server may determine the comparison feature by the feature determination layer of the parameter determination model.

In some embodiments, the reference charging record includes a first reference record and a second reference record, the first reference record is determined based on a historical charging record corresponding to a user terminal, the second reference record is determined based on a historical charging record corresponding to a reference terminal, and the reference terminal is a terminal other than the user terminal. In some embodiments, the comparison feature includes a first comparison feature and a second comparison feature, the first comparison feature corresponding to the first reference record, the second comparison feature corresponding to the second reference record. In some embodiments, training of the parameter determination model includes: determining a model learning rate based on a ratio of the first reference record to the second reference record in a training sample.

In some embodiments, the reference charging record may include the first reference record and the second reference record.

The first reference record refers to a reference charging record determined based on a historical charging record corresponding to the user terminal.

The historical charging record refers to data recorded in the history that the user used the charging pile to charge.

In some embodiments, a type of the historical charging record is similar to a type of the reference charging record. More descriptions regarding the reference charging record may be found in the FIG. 2 and related description thereof.

The second charging record refers to a reference charging record determined based on the historical charging record of the reference terminal. The reference terminal refers to a user terminal of the other user. For example, the reference terminal may be, for example, a smartphone of the other user.

In some embodiments, the cloud server may determine the first reference charging record and the second reference charging record based on a filtered historical charging record. More descriptions regarding determining the first reference charging record and the second reference charging record may be found in FIG. 4 and related descriptions thereof.

In some embodiments, in response to a determination that the reference charging record includes the first reference record and the second reference record, the comparison feature may include the first comparison feature and the second comparison feature.

The first comparison feature refers to a comparison feature corresponding to the first reference record.

In some embodiments, the first comparison feature may be the comparison feature of the first reference record and the pre-charging data.

The second comparison feature refers to a comparison feature corresponding to the second reference record.

In some embodiments, the second comparison feature may be the comparison feature of the second reference record and the pre-charging data. In some embodiments, the cloud server may pre-mark all reference charging records as either the first reference record or the second reference record. The cloud server inputs the marked reference charging records into the parameter determination model, which may result in marked comparison features. All of the output comparison features with markers may be the first comparison feature or the second comparison feature.

The parameter determination layer 362 refers to a model for determining the charging parameter. In some embodiments, the parameter determination layer 362 may be a machine learning model, e.g., a RNN, etc.

In some embodiments, according to FIG. 3, an input of the parameter determination layer 362 may include a pre-charging parameter 330, battery information 340, a charging requirement 350, and the comparison feature 370, and an output may include a charging parameter 380. The comparison feature 370 is the output of the feature determination layer 361.

The battery information refers to information related to a state of the battery and battery parameters. For example, the battery information may include, but is not limited to, one or more of a battery state (e.g., whether it is fully charged, whether it is charging), a percentage of battery level, a battery voltage, a battery temperature, a battery capacity, a charging type, or the like.

In some embodiments, the cloud server may automatically recognize the battery information through a direct input of the user or through a hardware interface.

More descriptions regarding the charging requirement and the pre-charging parameter may be found in FIG. 2 and FIG. 3 and related descriptions thereof.

In some embodiments, the cloud server may train the parameter determination model 360 based on a plurality of training samples with a training label.

In some embodiments, each of the training samples may include a sample reference charging record, sample pre-charging data, a sample pre-charging parameter, sample battery information, and a sample charging requirement, and the training label is a sample charging parameter corresponding to the training sample. The cloud server may obtain the training samples based on historical charging records, and the cloud server may determine the training label based on an actual charging parameter during a charging process. For example, the cloud server may filter the historical charging records, and determine the reference charging record, the pre-charging data, the pre-charging parameter, the battery information, and the charging requirement of the historical charging records that meet a filtering condition, respectively, as the sample reference charging record, the sample pre-charging data, the sample pre-charging parameter, the sample battery information, and the sample charging requirement of the training sample, and designate the actual charging parameter as the training label of the training sample. The filtering condition may be that a charging efficiency is greater than an efficiency threshold, and/or a charging duration when the battery adds the same electrical energy is less than a duration threshold, etc. The efficiency threshold and the duration threshold may be preset by the cloud server based on default settings or by a technician based on priori experience.

In some embodiments, the feature determination layer 361 and the parameter determination layer 362 of the parameter determination model 360 may be obtained based on joint training.

In some embodiments, the cloud server inputs the sample reference charging record and the sample pre-charging data into an initial feature determination layer to obtain a comparison feature output by the initial feature determination layer; and inputs the comparison feature output by the initial feature determination layer, the sample pre-charging parameter, the sample battery information, and the sample charging requirement into an initial parameter determination layer to obtain the charging parameter output by the initial parameter determination layer. The cloud server constructs a loss function based on the training label and the charging parameter output by the initial parameter determination layer, and synchronously updates the parameters of the initial feature determination layer and the initial parameter determination layer based on a value of the loss function. For example, the cloud server may update the parameters of the initial feature determination layer and the initial parameter determination layer based on a gradient descent algorithm. The training is completed when the loss function satisfies a preset condition, and a trained parameter determination model is obtained. The preset condition may be that the loss function converges, a count of iterations reaches a threshold, or the like.

In some embodiments, training of the parameter determination model may further include determining the model learning rate based on the ratio of the first reference record to the second reference record in the training sample.

The model learning rate refers to a parameter that controls an updating step of the parameter determination model. In some embodiments, the model learning rate may be used to determine a magnitude of a parameter for updating the parameter determination model.

In some embodiments, the model learning rate is positively correlated with a percentage of the first reference record. For example, the larger the percentage of the first reference record among the reference records, the larger the model learning rate. Understandably, since the first reference record is the historical charging record corresponding to the target charging device itself, it may reflect the charging requirement of the user, in addition to a charging parameter in terms of performance of the target charging device. Based on the first reference record, the charging parameter that is more in line with the charging requirement of the user may be obtained. The first reference record is more referential, and the cloud server updates the parameter determination model with a larger model learning rate when the first reference record has a larger percentage, and with a smaller model learning rate when the first reference record has a smaller percentage, which may ensure the accuracy of the parameter determination model.

In some embodiments of the present disclosure, the first reference record and the second reference record are used as the reference charging records, which in turn determines the first comparison feature and the second comparison feature, and the model learning rate is determined based on the percentages of the first reference record and the second reference record. It is conducive to improving the training effect of the parameter determination model, and thus obtaining more accurate charging parameter.

In some embodiments of the present disclosure, the charging parameter is determined based on the reference charging record using the parameter determination model, which can determine the charging parameter more accurately, thereby improving the charging efficiency and saving charging costs.

FIG. 4 is a flowchart illustrating an exemplary process for determining a reference charging record according to some embodiments of the present disclosure. As shown in FIG. 4, process 400 includes operations 410-460 as described below. In some embodiments, process 400 may be performed by a cloud server.

In some embodiments, the cloud server may be configured to: determine a pre-charging parameter based on the charging order information; pre-charge the target charging device, and obtain pre-charging data during a pre-charging process; identify whether the user terminal is a historical user terminal through the communication unit; in response to a determination that the user terminal is a historical user terminal, obtain a historical charging record corresponding to the user terminal; filter the historical charging record based on the pre-charging data; and determine a reference charging record based on the filtered historical charging record.

More descriptions regarding the pre-charging parameter and the pre-charging data may be found in FIG. 3 and related descriptions thereof.

In 410, the pre-charging parameter may be determined based on the charging order information. More descriptions regarding the process for determining the pre-charging parameter based on the charging order information may be found in FIG. 3 and related descriptions thereof.

In 420, the target charging device may be pre-charged, and the pre-charging data during the pre-charging process may be obtained. More descriptions regarding the process for charging the target charging device and obtaining the pre-charging data during the pre-charging process may be found in FIG. 3 and related descriptions thereof.

In 430, whether the user terminal is the historical user terminal may be identified through the communication unit.

The historical user terminal refers to a user terminal that has used the system for charging management to send the charging order information.

In some embodiments, the cloud server may determine, based on the historical charging record, whether the user terminal is the historical user terminal.

For example, at the end of each charging order, the communication unit uploads an acquired communication address of the user terminal and a current charging record to a communication address library of the cloud server for storage, and at the same time, deletes a local record. When the communication address of the user terminal is identified in a new charging order, the historical charging record corresponding to the communication address is retrieved in the communication address library through the cloud server. If the communication address of the user terminal has the historical charging record, the user terminal is judged to be the historical user terminal.

The communication address library refers to a database in which the cloud server saves the communication address of the user terminal and the charging order record corresponding to the communication address. The communication address library may include a relationship between the communication address and the charging order record.

More descriptions regarding the communication unit may be found in FIG. 2 and related descriptions thereof.

In 440, in response to the determination that the user terminal is the historical user terminal, the historical charging record corresponding to the user terminal may be obtained.

The historical charging record refers to a charging record stored in the cloud server for a historical time period.

In some embodiments, the historical charging record may be a charging record in which the communication unit uploads a charging order record generated in a device of the user to the cloud server.

In some embodiments, the cloud server may perform, based on the communication address of the user terminal, a query in the communication address library of the cloud server to obtain a historical charging record corresponding to the user terminal.

In 450, the historical charging record may be filtered based on the pre-charging data.

Since the user may charge a plurality of target charging devices through the user terminal, the cloud server needs to determine which of the historical charging records belong to the target charging device to get a more accurate historical charging record.

In some embodiments, the cloud server may intercept charging data of the historical charging records with the same charging duration as the pre-charging data; determine a first similarity between the intercepted charging data and the pre-charging data; and delete a historical charging record with a first similarity below a similarity threshold. The first similarity may be represented by a cosine distance, a Euclidean distance, a Mahalanobis distance, or the like, between a vector constructed from the intercepted charging data and a vector constructed from the pre-charging data.

In some embodiments, the cloud server may intercept the historical charging records based on the same battery level as the target charging device. For example, if the remaining battery level of the target charging device at the time of pre-charging is 20%, the cloud server may intercept the historical charging records from the time when the battery level is 20%.

The similarity threshold refers to a minimum value that the first similarity needs to reach. The cloud server may collect charging data during a plurality of charging processes of the target charging device with a same type, and determine a similarity between any two of the plurality of pieces of charging data; and designate the smallest similarity as the similarity threshold.

In 460, the reference charging record may be determined based on the filtered historical charging record.

In some embodiments, the cloud server designates, based on the pre-charging data, the historical charging data with a first similarity not less than the similarity threshold as the filtered historical charging data.

In some embodiments, the cloud server may identify the filtered historical charging record as the first reference record.

In some embodiments, the cloud server may also retrieve charging records of other users similar to the historical charging records as the second reference record. In some embodiments, the cloud server may determine whether the second reference record needs to be determined based on the count of the filtered historical charging records of the user terminal. For example, when the count of historical charging records filtered by the user terminal (i.e., the first reference records) does not reach a record count threshold, a manner similar to that for determining the first similarity is used to intercept the charging data of the charging records of other users with the same charging duration as that of the pre-charging data, determine a second similarity between the charging data of the intercepted charging records and the pre-charging data, and designate a charging record of other users with a relatively high second similarity as the second reference record.

In some embodiments, the record count threshold may be pre-set by the cloud server based on default settings, or by a technician based on priori experience. In some embodiments, the record count threshold may be determined based on a maximum similarity between the historical charging record corresponding to the user terminal and the pre-charging data. For example, the smaller the maximum similarity, the greater the need to retrieve more charging records of other users to be used as the reference charging record, and thus the greater the record count threshold.

In some embodiments of the present disclosure, the pre-charging parameter is determined based on the charging order information, and pre-charging is performed, the pre-charging data is obtained, the historical user terminal is recognized through the communication unit, and the historical charging records are obtained and filtered to determine the reference charging record, which is conducive to selecting the reference charging record in conjunction with the actual selection, improving a degree of matching between the reference charging record and a current user, and thus obtaining more appropriate charging parameter and improving charging efficiency.

It should be noted that the foregoing description of the process 400 is intended to be exemplary and illustrative only and does not limit the scope of application of the present disclosure. For a person skilled in the art, various corrections and changes may be made to the process 400 under the guidance of the present disclosure. However, these corrections and changes remain within the scope of the present disclosure.

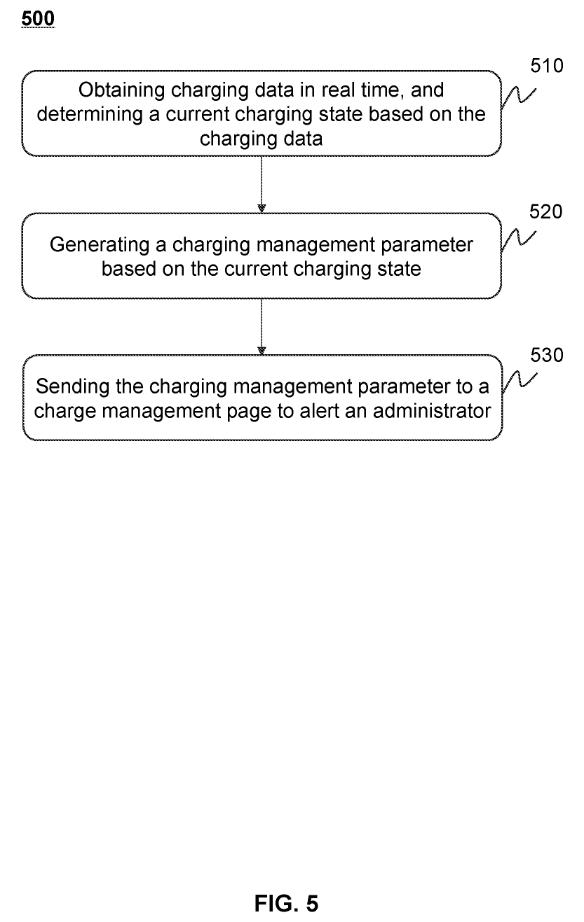

FIG. 5 is a flowchart illustrating an exemplary process for charging management according to some embodiments of the present disclosure. As shown in FIG. 5, process 500 includes operations 510- 530 as described below. In some embodiments, process 500 may be performed by a cloud server.

In some embodiments, in response to the determination that the state information is a charging state, the cloud server is further configured to: obtain charging data in real time, and determine a current charging state based on the charging data; generate a charging management parameter based on the current charging state, the charging management parameter including at least one of a charging adjustment parameter and a charging reminder parameter; and send the charging management parameter to the charge management page to alert an administrator, the administrator including the user and a management staff.

In some embodiments, in response to the state information being a charging state, the cloud server performs operations 510- 530.

In 510, the charging data may be obtained in real time, and the current charging state may be determined based on the charging data.

The charging data refers to data related to an actual charging process. In some embodiments, the charging data may include one or more of a current voltage, a present current, a current power, a current battery level, a temperature, or the like.

In some embodiments, the cloud server may communicate with the battery via a CAN bus protocol to obtain the current voltage, the present current, and the temperature of the battery, and estimate the current power and the current battery level in accordance with electrical theory based on the current voltage and present current.

The current charging state refers to a specific condition of the current charging process. In some embodiments, the current charging state may include a current charging progress, whether or not it is abnormal, and a type of abnormality. The type of abnormality includes charging disconnection, charging restart, charging speed too slow, charging temperature too high, or the like.

The charging progress refers to a current battery level of the battery in the charging data. In some embodiments, the charging progress may be used to determine the progress of charging. In some embodiments, the cloud server may designate a ratio or percentage of the current battery level as the charging progress.

In some embodiments, the cloud server compares data such as the current voltage, present current, and/or current power in the charging data to the charging parameter. If a difference between the current voltage and a charging voltage in the charging parameter is within a voltage difference range, a difference between the present current and a charging current in the charging parameter is within a current difference range, a difference between the current power and a charging power in the charging parameter is within a power difference range, and the battery temperature is also within a safe temperature range, the current charging state is normal; otherwise, the current charging state is abnormal. The voltage difference range, the current difference range, the power difference range, and the safe temperature range may be preset in advance. More descriptions regarding the charging parameter, the charging voltage, the charging current, and the charging power may be found in FIG. 2 and related descriptions thereof.

In response to a determination that the current charging state is abnormal, if the current voltage is 0 and the present current is 0, the cloud server judges that the type of abnormality is charging disconnection; if the voltage of one or more time periods in the charging data is 0 and the current is 0, the cloud server judges that the type of abnormality is charging restart; if the difference between the current voltage and the charging voltage in the charging parameter is not within the voltage difference range and the difference between the present current, the charging current in the charging parameter is not within the current difference range, and the difference between the current power and the charging power in the charging parameter is not within the power difference range, the cloud server determines that the type of abnormality is charging speed too slow.

In some embodiments, the cloud server may also determine a reference charging trend based on the charging parameter and the first reference record; and determine a current charging state based on the charging data and the reference charging trend. More descriptions regarding the first reference record maybe found in FIG. 3 and related descriptions thereof.

The reference charging trend refers to one or more curves used as a reference. In some embodiments, the reference charging trend may include a reference voltage curve, a reference current curve, a reference power curve, a reference temperature curve, etc. A reference voltage, a reference current, and a reference power refer to a voltage, a current, and a power that may be used as a reference during the charging process, respectively. The reference voltage curve, the reference current curve, the reference power curve, and the reference temperature curve refer to curves of the reference voltage, the reference current, the reference power, and a reference temperature versus time, respectively.

In some embodiments, the cloud server may determine the reference charging trend based on the charging parameter and the first reference record. For example, the cloud server may determine the reference charging trend by operations S11-S13.

In S11, an average of charging efficiencies in the first reference record may be designated as a reference charging efficiency. More descriptions regarding the charging efficiency may be found in FIG. 3 and related descriptions thereof.

The reference charging efficiency refers to a charging efficiency that may be designated as a reference during the charging process. In some embodiments, the cloud server may determine an average charging efficiency for the charging efficiencies in the first reference record as the reference charging efficiency.

In S12, based on the reference charging efficiency and in combination with the charging parameter, a reference voltage, a reference current, and a reference power for each time period may be determined during the charging process.

In some embodiments, the cloud server may determine, through the reference charging efficiency, an amount of electrical energy that is added to the battery at the charging power for each time period, as well as the amount of electrical energy used for heat generation; determine a voltage value divided by an internal resistance through a ratio between the amount of electrical energy that is added to the battery to the amount of electrical energy used for heat generation and the electrical theory , and thus determine the voltage, current, and power used for charging as the reference voltage, reference current, and reference power. In some embodiments, the cloud server may determine a temperature change resulting from the conversion of electrical energy to heat energy as a reference temperature based on the electrical energy used for heat generation for each time period and a specific heat capacity of the battery. The specific heat capacity is obtained by statistically determining a specific heat capacity of each of a plurality of batteries. The charging parameter is constant for each time period.

In S13, the reference voltage curve, the reference current curve, the reference power curve, and the reference temperature curve in the reference charging trend are plotted by the reference voltage, the reference current, the reference power, and the reference temperature for each time period.

In some embodiments, the cloud server may determine the current charging state based on the charging data and the reference charging trend. For example, the cloud server may draw a power curve and a temperature curve based on the charging data. If the power curve is smaller than the reference power curve and a power similarity between the two is less than a trend similarity threshold, the charging speed is judged to be abnormal; and if the temperature curve is larger than the reference temperature curve and the power similarity between the two is less than the trend similarity threshold, the temperature is judged to be abnormal. In some embodiments, the power and the temperature correspond to the same trend similarity threshold, and the trend similarity threshold is correlated to a variance of the charging efficiency in the first reference record. For example, the trend similarity threshold is negatively correlated to a variance of the charging efficiency in the first reference record. The greater the variance of the charging efficiency in the first reference record, indicating that data fluctuates widely even under normal conditions, the less the trend similarity threshold.

In some embodiments of the present disclosure, by determining the current charging state by determining the reference charging trend, an inconspicuous abnormality, such as slow charging speed, high charging temperature, etc., can be effectively analyzed to be handled in advance, effectively avoiding the abnormality from being further expansion.

In 520, the charging management parameter may be generated based on the current charging state.

The charging management parameter refers to a charging parameter to be managed.

In some embodiments, the charging management parameter includes, but is not limited to, at least one of a charging adjustment parameter and a charging reminder parameter.

The charging adjustment parameter refers to a parameter that adjusts the charging process. In some embodiments, the charging adjustment parameter includes, but is not limited to, at least one of an adjustment charging voltage, an adjustment charging current, and an adjustment charging power.

In some embodiments, the cloud server may determine the charging adjustment parameter in multiple ways. For example, the cloud server may determine the corresponding charging adjustment parameter based on an abnormal charging condition according to a preset rule. For example, if the current charging state is that the charging speed is too slow but the battery temperature is normal, the cloud server may restart charging or increase the charging power. As another example, if the battery temperature is too high, the cloud server may reduce the charging voltage, or stop charging and continue charging when the temperature is reduced within the safe temperature range.

In some embodiments, the cloud server may determine the abnormal cause based on the charging data, the charging parameter, the current charging state, and the reference charging trend using an anomaly analysis model, the anomaly analysis model being a machine learning model; and determine the charging adjustment parameter based on the abnormal cause.

The anomaly analysis model refers to a model for analyzing the abnormal cause of charging. In some embodiments, the anomaly analysis model may be a machine learning model, e.g., a CNN, a RNN, etc.

In some embodiments, an input of the anomaly analysis model may include the charging data, the charging parameter, the current charging state, and the reference charging trend; and an output may include the abnormal cause. More descriptions regarding the charging data, the charging parameter, the current charging state, and the reference charging trend may be found elsewhere in the present disclosure (e.g., FIG. 2, FIG. 5, operation 510, and related descriptions thereof).

The abnormal cause refers to a cause of the abnormal charging condition. In some embodiments, the abnormal cause may include one or more of an excessive voltage, excessive charging duration, excessive ambient temperature, etc.

In some embodiments, the anomaly analysis model may be obtained based on anomaly training samples with an anomaly training label. In some embodiments, the anomaly training samples may be constructed based on historical anomaly records and include one or more of the historical charging data, the historical charging parameter, the historical current charging state, and the historical reference charging trend in the historical anomaly record. The anomaly training label is an abnormal cause obtained by a professional technician after analyzing the charging data in the historical anomaly record. The anomaly analysis model is trained in a similar manner as the parameter determination model, and more descriptions may be found in FIG. 3 and related descriptions thereof.

In some embodiments, the cloud server may determine the charging adjustment parameter based on the abnormal cause. For example, the cloud server may determine the charging adjustment parameter based on a cross-reference table. The cross-reference table may be preset by a human based on experience. In some embodiments, contents of the cross-reference table may include, but are not limited to: if the voltage is too high, the charging adjustment parameter is to reduce the voltage; if the charging duration is too long, the charging adjustment parameter is to suspend charging until the temperature is reduced to the safe temperature range; and if the ambient temperature is too high, the charging adjustment parameter is to lower the ambient temperature. The manner of lowering the ambient temperature includes, but is not limited to, spraying water to lower the temperature, or lowering the temperature by a fan.

In some embodiments of the present disclosure, according to the anomaly analysis model, the charging adjustment parameter is determined by determining the abnormal cause, which can determine the adjustment manner more accurately and efficiently, and effectively reduce the negative impact brought by the abnormality.

The charging reminder parameter refers to a parameter that reminds the charging progress and the abnormal charging condition. In some embodiments, the charging reminder parameter may include one or more of the charging reminder parameter to remind of the imminent completion of charging, the charging reminder parameter for the abnormal charging condition, or the like.

In some embodiments, the cloud server may determine the charging reminder parameter in multiple ways. For example, the cloud server may determine the corresponding charging reminder parameter according to a preset table based on the current charging state and the execution of the charging adjustment parameter. For example, the preset table includes that: in response to a determination that an expected remaining charging time determined based on the charging progress is less than a waiting time threshold, the cloud server generates the charging reminder parameter for the completion of charging. The charging reminder parameter for the completion of charging may include one or more of an imminent end reminder, a remaining charging duration, a current battery level, etc. As another example, the preset table includes: in response to charging disconnection or charging restart, or a charging state that does not return to normal after executing with the charging adjustment parameter, the cloud server may generate the charging reminder parameter for charging abnormality. The charging reminder parameter for charging abnormality may include one or more of an abnormality type, an executed charging adjustment parameter, or the like.

In some embodiments, the cloud server is further configured to, in response to a determination that the user submits the charging order information, send a push permission request to the user via the charge management page; in response to a determination that the user agrees to the push permission request, obtain positioning information of the user at a preset node; and determine the charging reminder parameter based on the positioning information and a charging progress to send a completion reminder message to the user.

In some embodiments, the cloud server performs operations S21- S23 to determine the charging reminder parameter.

In S21, in response to the determination that the user submits the charging order information, the push permission request may be sent to the user via the charge management page.

The push permission request refers to a request that alerts the user to bind an account to get real-time message alerts. In some embodiments, when the user agrees to the push permission request, the cloud server may obtain account binding information to push a subsequent message.

In some embodiments, the cloud server may, in response to a determination that the user submits the charging order information, send a push permission request to the user via the charge management page. For example, the cloud server may send the push permission request by sending a pop-up window on the charge management page after the user scans a code to submit the order.

In S22, in response to the determination that the user agrees to the push permission request, the positioning information of the user may be obtained at the preset node.

The positioning information refers to a specific location of the user. In some embodiments, the cloud server may, in response to the determination that the user agrees to the push permission request, obtain the positioning information of the user at the preset node. For example, the cloud server recognizes a latitude and longitude location of the user terminal as the u positioning information.

The preset node refers to a time node at which the location of the user is obtained. For example, the preset node includes a node where the charging reaches 80%, a node where there are 30 minutes left until the end of charging, or the like.

In some embodiments, the cloud server may determine the preset node in multiple ways. For example, the preset node may be obtained predefined.

In some embodiments, the cloud server may determine the preset node based on battery level distribution information of the user, and the battery level distribution information is related to a battery level at the end of charging in the historical charging record for the user.

The battery level distribution information refers to a battery level at the end of charging in the historical charging data for the user.

In some embodiments, the battery level distribution information relates to battery levels at the end of charging in a plurality of historical charging records. For example, the battery level distribution information is a sequence including the battery levels at the end of charging in the plurality of historical charging records. Exemplarily, assuming that the count of charging times of user A is 20, the battery level distribution information is obtained based on the 20 pieces of historical charging data as ((100%, 10), (90%, 8), (70%, 2)), wherein (100%, 10), (90%, 8), and (70%, 2) represent that the vehicle's battery level at the end of charging of user A is 100% for 10 times, the vehicle's battery level at the end of charging of user A is 90% for 8 times, and the vehicle's battery level at the end of charging of user A is 70% for 2 times.

In some embodiments, the cloud server may determine the preset node based on the battery level distribution information of the user. For example, the cloud server may determine the preset node based on the battery level when a count of occurrences of the battery level distribution information is greater than a preset threshold in combination with a preset lead time. Exemplarily, the battery level distribution information of user A is ((100%, 10), (90%, 8), (70%, 2)), and if the preset threshold is 5 times and the preset lead time is 20 minutes, the following two preset nodes may be obtained. The two preset nodes include a preset node 1, which is a time node with 20 minutes left until charging to 100%; and a preset node 2, which is a time node with 20 minutes left until charging to 90%. It should be noted that as the preset node 1, the user may be alerted to a remaining time for charging to 100%; and as the preset node 2, the user may be alerted to the remaining time for charging to 100% and/or the remaining time for charging to 90%.

The preset threshold refers to a pre-set battery level threshold.

In some embodiments, the cloud server may set the preset threshold based on experience.

The preset lead time is a length of time to notify the user in advance.

In some embodiments, the cloud server may determine the preset lead time in advance based on experience.

In some embodiments, the cloud server may obtain historical behavior data of the user; based on the historical behavior data, determine a behavioral habit feature of the user; and based on the behavioral habit feature and the positioning information of the user, determine the preset lead time.

The historical behavior data refers to data on the user's behavioral habits during historical charging processes. In some embodiments, the historical behavior data may include a time point when the system sends the charging reminder parameter to the user and time points when the user arrives at the charging pile, unplugs the charging gun, and ends charging.

In some embodiments, the historical behavior data may be obtained from a cloud database.

The behavioral habit feature refers to how long it takes for the user to start heading to the charging pile after receiving the message. For example, the behavioral habit feature may include going immediately, going later, and a duration for which the going is delayed. Exemplarily, if the user travels in the direction of the charging pile immediately after receiving the message and the charging has not yet ended when the user arrives, the cloud server determines that the behavioral habit feature is going immediately. If the user does not travel in the direction of the charging pile immediately after receiving the message and the charging has already ended when the user arrives, the cloud server determines that the behavioral habit feature is going later. and determines a difference between the time the user arrives at the charging pile and the end of charging as the duration for which the going is delayed. Whether or not the user travels in the direction of the charging pile immediately after receiving the message may be determined by the positioning information of the user.

In some embodiments, the cloud server may determine the preset lead time based on the behavioral habit feature and the positioning information of the user. For example, if the behavioral habit feature is going immediately, the base lead time is set as a smaller length of time; for example, the preset lead time includes 0 minute, 1 minute, 2 minutes, etc. If the behavioral habit feature is going later, the duration for which the going is delayed is used as the base lead time. Next, the cloud server may determine an activity range of the user based on the positioning information of the user during the time period after charging has started and adjust the base lead time based on the activity range. The larger the activity range, the farther the user is likely to travel in a short time period, and the preset lead time is adjusted to increase to ensure that the user can make it back to the charging pile on time. The adjusted value may be determined based on a size of the activity range and a walking speed of the user. Exemplarily, based on the positioning information of user B during the time period after charging has started, it is determined the user B is active in a range centered on the charging pile with a radius of 300 meters. If the user B is traveling at a speed of 60 meters per minute, the cloud server determines that the adjusted value of the preset lead time is 5 minutes through dividing 300 by 60.

In some embodiments of the present disclosure, determining the preset node based on the battery level distribution information allows for more personalized pushing of information to the user and improves user satisfaction.

In S23, the charging reminder parameter may be determined based on the positioning information and the charging progress to send the completion reminder message to the user. More descriptions regarding the charging progress may be found above.

In some embodiments, the charging reminder parameter may include whether to send a reminder message and a message content. For example, the charging reminder parameter may include the remaining charging time, the current charging progress, or the like.

In some embodiments, the cloud server may estimate a length of time for the user to travel to the charging pile based on the positioning information of the user, the location information of the charging pile, and the walking speed, and if the length of time for the user to travel to the charging pile satisfies a sending condition, send a reminder message to the user. The cloud server may determine a walking speed of an average adult or an average of historical walking speeds of the user as the walking speed.

The sending condition refers to a condition for sending that is preset in advance. In some embodiments, the sending condition may include that the length of time for the user to travel to the charging pile is greater than or equal to a length of time required for the battery to be full or that the length of time for the user to travel to the charging pile is less than the length of time for the battery to be full and a difference is less than a waiting time threshold. The difference refers to a difference between the length of time for the user to travel to the charging pile and the length of time required for the battery to be full. The length of time required for the battery to be full may be predicted by the cloud server based on the current charging progress and charging parameter. The waiting time threshold is a maximum length of time of the user waiting for the battery to be full after arriving at the charging pile. In some embodiments, the waiting time threshold may be set based on a current idle rate of the charging pile. For example, the lower the current idle rate is, the larger the waiting time threshold is, and the cloud server may remind the user to go to the charging pile to end charging as soon as possible.

In some embodiments of the present disclosure, the cloud server obtains the positioning information of the user at the preset node and determines the charging reminder parameter based on the positioning information and the charging progress, which not only facilitates the user's trip arrangement according to a requirement to improve the user's experience but also effectively reduces the prolonged occupation of the charging pile, and thus improves the utilization efficiency of the charging pile.

In 530, the charging management parameter may be sent to the charge management page to alert the administrator.

In some embodiments, the administrator may include the user and a management staff. For example, the cloud server sends a normal charging reminder parameter alerting that charging is about to be completed to the user; and the cloud server sends a charging reminder parameter alerting that charging is abnormal to both the user and the management staff. The cloud server may remind the administrator through a pop-up window, voice reminder, text reminder, or the like.

In some embodiments of the present disclosure, by determining the current charging state, generating charging management parameter, and sending the charging management parameter to the charge management page to remind the administrator, not only the user can be more accurately reminded to end of charging, but it can also reduce the user's waiting time to a greater extent. At the same time, the effective utilization rate of the charging pile is increased, which is convenient for the user to use and for the management staff to manage. It also enables the management staff to discover any abnormal situation in a timely manner and effectively avoid the expansion of the abnormality.

It should be noted that the foregoing description of process 500 is intended to be exemplary and illustrative only and does not limit the application scope of the present disclosure. For a person skilled in the art, various corrections and changes may be made to process 500 under the guidance of the present disclosure. However, these corrections and changes remain within the scope of the present disclosure.

One or more embodiments of the present disclosure provide a non-transitory computer-readable storage medium storing a set of computer instructions. When a computer reads the computer instructions in the storage medium, the method for charge management is implemented.

In addition, the particular features, structures, or characteristics may be combined as suitable in one or more embodiments of the present disclosure.

In some embodiments, numbers describing the number of ingredients and attributes are used. It should be understood that such numbers used for the description of the embodiments use the modifier "about", "approximately", or "substantially" in some examples. Unless otherwise stated, "about", "approximately", or "substantially" indicates that the number is allowed to vary by ±20%. Correspondingly, in some embodiments, the numerical parameters used in the description and claims are approximate values, and the approximate values may be changed according to the required characteristics of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

What is claimed is:

1. A system for charge management comprising a charging pile, an interaction device, and a cloud server, wherein the interaction device is matched with the charging pile;
the charging pile is configured to charge a target charging device;
the interaction device is configured to present a connection request port corresponding to the charging pile to a user; and
the cloud server is configured to:
in response to a determination that a user terminal sends a connection request through the connection request port, obtain state information of the charging pile;
in response to a determination that the state information is an idle state,
display a charging request page to the user via the user terminal and obtain charging request information of the user, the charging request information including at least one of charging order information and identity verification information;
generate a charging parameter based on the charging order information, the charging parameter including at least one of a charging voltage, a charging current, and a charging power; and
send a charging command to the charging pile to start charging; and
in response to a determination that the state information is a charging state:
send an identity verification request to the user via the user terminal; and
in response to a determination that the identity verification request is passed, display a charge management page to the user via the user terminal, the charge management page being configured to display at least one of the charging parameter and an estimated charging duration to the user.

2. The system of claim 1, wherein the interaction device includes a communication unit, and the communication unit is configured to:
in response to a determination that the charging request information is obtained, send a communication connection request to the user terminal;
in response to a determination that the communication connection request is passed, obtain a communication address of the user terminal;
scan the communication address in real time during a charging process; and
in response to a determination that the communication address is scanned, display the connection request port to the user via the interaction device.

3. The system of claim 1, wherein the cloud server is further configured to:
obtain a reference charging record of the user based on the charging order information; and
determine the charging parameter based on the reference charging record.

4. The system of claim 3, wherein the cloud server is further configured to:
determine the charging parameter based on the reference charging record using a parameter determination model, the parameter determination model being a machine learning model, the parameter determination model including a feature determination layer and a parameter determination layer; wherein
an input of the feature determination layer includes the reference charging record and pre-charging data, and an output of the feature determination layer includes a comparison feature; and
an input of the parameter determination layer includes the comparison feature, a pre-charging parameter, battery information, and a charging requirement, and an output of the parameter determination layer includes the charging parameter.

5. The system of claim 4, wherein the reference charging record includes a first reference record and a second reference record, the first reference record is determined based on a historical charging record corresponding to the user terminal, the second reference record is determined based on a historical charging record corresponding to a reference terminal, and the reference terminal is a terminal other than the user terminal;
the comparison feature includes a first comparison feature and a second comparison feature, the first comparison feature corresponding to the first reference record, the second comparison feature corresponding to the second reference record; and
training of the parameter determination model includes: determining a model learning rate based on a ratio of the first reference record to the second reference record in a training sample.

6. The system of claim 3, wherein the cloud server is further configured to:
determine a pre-charging parameter based on the charging order information;
pre-charge the target charging device, and obtain pre-charging data during a pre-charging process;
identify whether the user terminal is a historical user terminal through a communication unit;
in response to a determination that the user terminal is the historical user terminal, obtain a historical charging record corresponding to the user terminal;
filter the historical charging record based on the pre-charging data; and
determine the reference charging record based on the filtered historical charging record.

7. The system of claim 1, wherein in response to the determination that the state information is the charging state, the cloud server is further configured to:
obtain charging data in real time, and determine a current charging state based on the charging data;
generate a charging management parameter based on the current charging state, the charging management parameter including at least one of a charging adjustment parameter and a charging reminder parameter; and
send the charging management parameter to the charge management page to alert an administrator, the administrator including the user and a management staff.

8. The system of claim 7, wherein the cloud server is further configured to:
determine a reference charging trend based on the charging parameter and a first reference record; and
determine the current charging state based on the charging data and the reference charging trend.

9. The system of claim 7, wherein the cloud server is further configured to:
determine an abnormal cause using an anomaly analysis model based on the charging data, the charging parameter, the current charging state, and a reference charging trend, the anomaly analysis model being a machine learning model; and
determine the charging adjustment parameter based on the abnormal cause.

10. The system of claim 7, wherein the cloud server is further configured to:
in response to a determination that the user submits the charging order information, send a push permission request to the user via the charge management page;
in response to a determination that the user agrees to the push permission request, obtain positioning information of the user at a preset node; and
determine the charging reminder parameter based on the positioning information and a charging progress to send a completion reminder message to the user.

11. The system of claim 10, wherein the cloud server is further configured to:
determine the preset node based on battery level distribution information of the user, the battery level distribution information being related to a plurality of battery levels when the user ends charging in a plurality of historical charging records.

12. A method for charge management executed by a cloud server, comprising:
in response to a determination that a user terminal sends a connection request through a connection request port corresponding to a charging pile, obtaining state information of the charging pile, the connection request port being displayed by an interaction device to a user;
in response to a determination that the state information is an idle state:
displaying a charging request page to the user via the user terminal and obtain charging request information of the user, the charging request information including at least one of charging order information and identity verification information;
generating a charging parameter based on the charging order information, the charging parameter including at least one of a charging voltage, a charging current, and a charging power; and
sending a charging command to the charging pile to start charging a target charging device by the charging pile; and
in response to a determination that the state information is a charging state:
sending an identity verification request to the user via the user terminal; and
in response to a determination that the identity verification request is passed, displaying a charge management page to the user via the user terminal, the charge management page being configured to display at least one of the charging parameter and an estimated charging duration to the user.

13. The method of claim 12, wherein the generating a charging parameter based on the charging order information includes:
obtaining a reference charging record of the user based on the charging order information; and
determining the charging parameter based on the reference charging record.

14. The method of claim 13, wherein the determining the charging parameter based on the reference charging record includes:
determining the charging parameter based on the reference charging record using a parameter determination model, the parameter determination model being a machine learning model, the parameter determination model including a feature determination layer and a parameter determination layer; wherein
an input of the feature determination layer includes the reference charging record and pre-charging data, and an output of the feature determination layer includes a comparison feature; and
an input of the parameter determination layer includes the comparison feature, a pre-charging parameter, battery information, and a charging requirement, and an output of the parameter determination layer includes the charging parameter.

15. The system of claim 14, wherein the reference charging record includes a first reference record and a second reference record, the first reference record is determined based on a historical charging record corresponding to the user terminal, the second reference record is determined based on a historical charging record corresponding to a reference terminal, and the reference terminal is a terminal other than the user terminal;
the comparison feature includes a first comparison feature and a second comparison feature, the first comparison feature corresponding to the first reference record, and the second comparison feature corresponding to the second reference record; and
training of the parameter determination model includes: determining a model learning rate based on a ratio of the first reference record to the second reference record in a training sample.

16. The method of claim 13, wherein the obtaining a reference charging record of the user based on the charging order information includes:
determining a pre-charging parameter based on the charging order information;
pre-charging the target charging device, and obtaining pre-charging data during a pre-charging process;
identifying whether the user terminal is a historical user terminal through a communication unit;
in response to a determination that the user terminal is the historical user terminal, obtaining a historical charging record corresponding to the user terminal;
filtering the historical charging record based on the pre-charging data; and
determine the reference charging record based on the filtered historical charging record.

17. The method of claim 12, wherein in response to the determination that the state information is the charging state, the method further includes:
obtaining charging data in real time, and determining a current charging state based on the charging data;
generating a charging management parameter based on the current charging state, the charging management parameter including at least one of a charging adjustment parameter and a charging reminder parameter; and
sending the charging management parameter to the charge management page to alert an administrator, the administrator including the user and a management staff.

18. The method of claim 17, wherein the determining a current charging state based on the charging data includes:
determining a reference charging trend based on the charging parameter and a first reference record; and
determining the current charging state based on the charging data and the reference charging trend.

19. The method of claim 17, wherein the generating a charging management parameter based on the current charging state includes:
determining an abnormal cause using an anomaly analysis model based on the charging data, the charging parameter, the current charging state, and a reference charging trend, the anomaly analysis model being a machine learning model; and
determine the charging adjustment parameter based on the abnormal cause.

20. A non-transitory computer-readable storage medium storing a set of computer instructions, wherein when a computer reads the computer instructions in the storage medium, the method for charge management of claim 12 is implemented.
